(19) United States
(12) Patent Application Publication
(10) Pub. No.: US 2021/0298322 A1
(43) Pub. Date: Sep. 30, 2021

(54) CHEWING GUM COMPRISING FUNCTIONAL SWEETENER

(71) Applicant: SAMYANG CORPORATION, Seoul (KR)

(72) Inventors: Il SEO, Gwanagju-si (KR); Bong Chan KIM, Seoul (KR); Yong-In KIM, Yongin-si (KR); Seung Mi LEE, Hwaseong-si (KR); Su Youn LIM, Seoul (KR); Hye Jin LIM, Seongnam-si (KR); Tae-Chul HAN, Hwaseong-si (KR)

(21) Appl. No.: 17/267,197

(22) PCT Filed: Aug. 10, 2018
(86) PCT No.: PCT/KR2018/009200

§ 371 Date: Feb. 9, 2021

(51) Int. Cl. A23G 4/10; A23G 4/06; A23G 4/08

(52) U.S. Cl. CPC A23G 4/10; A23V 2002/00; A23G 4/08; A23G 4/066

(57) ABSTRACT

The present invention provides a chewing gum composition comprising a functional sweetener, which has high sweetness sustainability, excellent refreshing feeling, excellent organoleptic properties, low hygroscopicity, and excellent storage stability.

### TECHNICAL FIELD

The present invention relates to an allulose-containing chewing gum having excellent sweetness and refreshing feeling, and is to provide a chewing gum having excellent sensory properties and excellent storage stability by containing sugar and allulose as saccharides.

### RELATED ART

Chewing gum refers to a natural or synthetic resin blended with a plasticizer, a filler, a sweetener, a flavoring agent, and the like, and is classified depending on the shape or ingredient into plate gum (commonly commercialized gum), balloon gum, sugar coated gum, and sugarless gum which is prepared by adding sugar alcohols such as sorbitol, mannitol, xylitol, etc., in place of sugar, center filling gum (gum in which syrup, jam, powder, or the like is filled into the internal part of gum), and the like.

In particular, in recent years, the consumption of sugar-free gums has been increased due to obesity, adult diseases, or etc. and there has been a demand for ingredients giving a sweet taste instead of sugar. In particular, D-allulose, also called D-psicose has a sweetness of about 70% of the sweetness of sugar but has little calories, and thus has been studied as a sweet component of chewing gum instead of sugar. However, when D-allulose is used, there is a problem that the saccharide content is slightly low relative to sugar, and the chewing gum has an increased hardened strength and thus becomes tough.

Meanwhile, in general, an emulsifier is used to keep the sweet taste and flavor of a chewing gum for a long time. According to a number of previous studies, when using an emulsifier for chewing gum, the hydrophile-liphophile balance (HLB) must be set to a high value (for example, at least 10), so that the use of emulsifiers has an effect on maintaining the taste.

### DISCLOSURE

### Technical Problem

An object of the present invention is to provide a chewing gum composition containing sugar, allulose and an emulsifier, and a method for producing the same.

Another object of the present invention is to provide a method of providing improved storage stability and sweet taste persistence to a chewing gum composition by providing sugar, allulose and emulsifier.

### Technical Solution

The inventors of the present invention have developed a chewing gum composition which has a low-calorie and a refreshing feeling compared to a composition containing the same amount of sugar as a saccharide as well as more excellent sweetness, and has excellent storage stability due to low hygroscopicity.

The present invention will now be described in more detail.

An embodiment of the present invention provides a chewing gum composition containing allulose.

For example, the chewing gum composition of the present invention may be a chewing gum composition comprising a gum base, allulose and an emulsifier.

As another embodiment of the present invention, there is provided a chewing gum composition comprising a gum base, allulose and an emulsifier, wherein the emulsifier has an HLB value of 1 to 8.

Another embodiment of the present invention provides a sugar-free chewing gum composition comprising a gum base, allulose, a sugar alcohol and an emulsifier, wherein the emulsifier has an HLB ((hydrophile-liphophile balance) value of 1 to 8.

The allulose contained in the chewing gum composition of the present invention is a monosaccharide with low-calorie, also called as psicose, and has advantageously a high sweetness equivalent to that of sugar while reducing excessive intake of sugar and having a good effect for preventing adult diseases such as diabetes and obesity. Allulose may be included at 1 to 70% by weight, or preferably 10 to 40% by weight based on 100% by weight of the total solid contents of chewing gum composition. By including allulose at the range in the chewing gum composition, not only the strength can be maintained appropriately without blurring in chewing of the chewing gums, but also the sweetness can be kept long. In particular, the chewing gum composition of the present invention containing allulose is characterized by excellent persistence of sweetness even when an emulsifier having a low HLB value is used.

The allulose contained in the chewing gum composition may be added by syrup or powder form. When the allulose powder is used, the solid content of allulose powder may be used by allulose powder of allulose purity of 90% or more in a total allulose powder. The allulose syrup may be a solution prepared from allulose at various concentrations. When allulose is contained as a mixed saccharide syrup containing allulose, the mixed saccharide syrup containing allulose may contain 2 to 55 parts by weight of allulose, 30 to 80 parts by weight of fructose and 2 to 60 parts by weight of glucose, and 0.01 to 15 parts by weight of oligosaccharide, based on 100 parts by weight of the total solid content of mixed saccharide syrup, and it may not contain the oligosaccharide. The allulose, fructose and glucose are preferably all D-isomer.

The allulose used in the chewing gum composition of the present invention may be allulose crystals, for example, allulose crystals having one or more properties selected from the group consisting of the following (1) to (6).

(1) having an X-ray spectrum which has a peak at angles of diffraction (2θ)±0.2° of (a) 15.35, 30.95, 18.83, and 47.15; or (b) 15.35, 30.95, 18.83, 47.15, and 25.17,

(2) Tm temperature of 125.8° C.±5° C. according to a differential scanning calorimetry analysis (DSC),

(3) enthalpy of melting (LH) of 200 to 220 J/g according to a differential scanning calorimetry analysis,

(4) a mean long diameter of 400 μm or more,

(5) a ratio of long diameter length (micrometer) to short diameter of the crystal (=long diameter/short diameter) in the range of 1.5 to 6.9, and

(6) a rectangular parallelepipedal shape.

The allulose may be one prepared by chemical synthesis or by biological method using allulose epimerization enzyme. Preferably, allulose can be prepared by a biological method, for example by a microorganism or enzymatic reaction. For example, the mixed saccharides may be mixed saccharides produced by reacting an allulose-producing composition comprising at least one selected from the group consisting of an allulose epimerase, a microbial cell of a microorganism producing the enzyme, culture of the microorganism, a lysate of the microorganism, and an extract of the lysate or the culture with a fructose-containing raw material, or obtained therefrom.

As an example for preparing allulose in the present invention, an expression system capable of producing allulose epimerase at a high expression rate and stability, a GRAS (Generally recognized as safe) microorganism using the expression system, and a method of producing an allulose including microorganism and enzyme using the expression system are described in detail in Korean Patent Nos. 10-1318422 and 10-1656063.

The emulsifier contained in the chewing gum composition of the present invention is a substance to which forms a stable emulsion with two kinds of immiscible liquids, and is expressed by a hydrophilic-lipophilic-balance (HLB) value depending on the ratio of hydrophilicity and lipophilicity. That is, the large HLB value means that the ratio of hydrophilicity is high, and the small HLB value is the low ratio of hydrophilicity.

In the conventional art, because many oil-based flavors are used as components imparting taste and flavor in chewing gums, it has been desirable to add an emulsifier having a high HLB value, for example an HLB value of at least 10 or more, in order to sustain the taste and flavor of the chewing gum for a long time.

The emulsifier contained in the chewing gum composition of the present invention may be an emulsifier having an HLB value of 1 to 10, preferably 1 to 8, or more preferably 1 to 3. Furthermore, the chewing gum composition of the present invention may comprise 0 to 3% by weight, or preferably 0.1 to 1% by weight of the emulsifier, based on 100% by weight of the total solid content of the chewing gum composition.

Specific examples of the emulsifier include an emulsifier having an HLB of 6 or less, which may be monoglycerin fatty acid ester, sorbitan fatty acid ester, and polyglycerin polyricinoleate, wherein the fatty acid has 10 to 18 carbon atoms, or preferably 16 to 18 carbon atoms. The emulsifier may specifically be one or more of monoglyceride and diglycerides (MD), sorbitan monostearate (SMS), sorbitan tristearate (STS), polyglycerol ester (PGE), lactic acid ester of monoglyceride and diglyceride (LMD), phosphorate (PMD) of monoglyceride and diglyceride, diacetyl tartrate of monoglyceride (DATEM), sugar ester and lecithin. The lecithin comprises soybean lecithin and egg yolk lecithin, or preferably soybean lecithin, the glycerin fatty acid ester is monoglyceride stearate, and the sorbitan fatty acid esters may be sorbitan oleate and sorbitan stearate.

The chewing gum composition has low moisture absorption as compared with chewing gum containing an emulsifier having a high HLB value, because it uses an emulsifier with a low HLB value. Thus, there is no problem that the physical properties of the gum become soft due to the absorbed moisture from the air during storage, and that the gum adheres to a wrapper or the like, thereby providing an excellent storage stability. For example, the chewing gum composition may have low hygroscopicity, and thus the hygroscopicity degree of gum can be 0.1 to 2.3%, or preferably 0.5 to 2.0% as calculated by the following formula (1), when it is stored at a temperature of 30° C. and a relative humidity of 75% RH for 8 hours.

Hygroscopicity (%)={(weight of chewig gum at n hour)−(weight of chewing gum at 0 hour)}/(weight of chewing gum at n hour)×100% [Equation 1]

In particular, when a chewing gum is commercially provided, the color, physical properties, flavor and the like of the gum become quality indicators in setting the shelf life. Particularly, considering that the important factor affecting such quality indicators is moisture, a chewing gum composition having low hygroscopicity has very large advantages in terms of maintenance of quality and extension of the shelf life.

In addition, it is known that there is a problem of organoleptic properties that the sweetness of conventional chewing gum composition becomes low or is not maintained for a long time, when an emulsifier having a low HLB value is used. However, the chewing gum composition of the present invention is not only excellent in sweetness compared to a composition comprising allulose or sugar alone, by including allulose and sugar in a specific amount as saccharides, but also excellent in sweet taste prolongation, so that the problem of reduced sweetness or reduced persistence due to the use of an emulsifier having a low HLB value can be solved.

The chewing gum composition of the present invention may further comprise one or more saccharides selected from the group consisting of monosaccharides other than allulose, disaccharides, sugar alcohols, dietary fibers and oligosaccharides.

For example, the monosaccharides and disaccharides may be one or more selected from the group consisting of sugar, allose, deoxyribose, erythrulose, galactose, idose, mannose, ribose, solvose, tagatose, erythrose, fuculose, gentiobiose, genthiobiulose, isomaltose, isomaltulose, kojibiase, lactulose, altrose, laminariviose, arabinose, leucrose, fucose, rhamnoses, sorbose, maltulose, mannobiose a mannosesucrose, melezitose, meliviose, meliviulose, nigerose, raffinose, rutinose, lutinulose, stachyose, threose, trehalose, trehalulose, toranose, xylose, fructose, and glucose.

For example, allulose and sugar as saccharides can be mixed and used in the chewing gum composition, and can impart a refreshing feeling derived from saccharides, specifically imparted by allulose, and has an effect of not only good sweetness compared to a composition containing the same amount of sugar or allulose alone as saccharides but also maintaining sweetness longer during chewing. The sugar and allulose included in the chewing gum composition may be contained in a weight ratio of 99:1 to 1:99, preferably 99:1 to 50:50, or more preferably 75:25 to 65 to 35.

The sugar contained in the chewing gum composition may be white sugar, brown sugar or the like depending on the degree of purification, and may be refined sugar, fine sugar, caster sugar or powder sugar depending on average particle size, and the sugar may be contained in an amount of 50 to 90% by weight, or preferably 60 to 70% by weight based on 100% by weight of the total chewing gum composition.

Alternatively, the chewing gum composition of the invention may be sugar-free or sugarless chewing gum composition which does not contain sugar as a saccharide. The sugar-free chewing gum composition can not only reduce the possibility of inducing adult diseases or metabolic diseases caused by sugar, but also prevent stickiness caused by addition of sugar, and prevent the tooth decay.

The sugar alcohols may be at least one selected from the group consisting of xylitol, maltitol, erythritol, mannitol, lactitol, inositol and sorbitol. The dietary fibers may be water-soluble dietary fibers, and the water-soluble dietary fibers can be at least one selected from the group consisting of polydextrose, indigestible maltodextran, and pectin. The oligosaccharides may be at least one selected from the group consisting of fructooligosaccharide, isomaltooligosaccharide, maltooligosaccharide and galactooligosaccharide.

For example, the chewing gum composition may further contain a sugar alcohol as a saccharide. Commonly, the chewing gum composition containing sugar alcohol, it has a problem of having a low hardness, i.e., a blurred physical property compared to a chewing gum composition containing sugar as saccharide. However, the hardness of the chewing gum containing sugar alcohol increases by using allulose in the chewing gum composition of the present invention, so as to complement the physical property.

The gum base in the chewing gum composition of the present invention may comprise one or more selected from the group consisting of synthetic and/or natural elastic polymers such as polyisoprene, polyvinyl acetate, polyisobutylene, ester gums, natural gums, latex, resins (e.g. terpene resins), polyvinyl esters and alcohols.

For example, it may comprise 20 to 50% by weight of polyvinyl acetate, 5 to 20% by weight of polyisobutylene, and/or 3 to 45% by weight of ester gum, based on 100% by weight of gum base. The gum base may further comprise one or more selected from the group consisting of lubricants, waxes (e.g., candelilla wax, carnauba wax, microcrystalline wax, petroleum wax, bead wax, and/or refined paraffin wax), emulsifiers, polybutenes, fillers (for example, talc and or calcium carbonate), high-intensity sweeteners, acidulants, flavors, functional materials, and thickening polysaccharides, but not limited to. For example, 20-50% by weight of polyvinyl acetate, 5-20% by weight polyisobutylene, 1-20% by weight of wax, 0.5-10% by weight of emulsifier, 10-20% by weight of talc, 10-20% by weight of calcium carbonate, 1-2% by weight of plasticizer, 20-30% by weight of ester gum, 1-6% by weight of natural sweetener, 1-3% by weight of flavor, and 0.1-5% by weight glycerin, based on 100% by weight the gum base, but not limited thereto.

The chewing gum composition of the present invention may further comprise at least one additive selected from the group consisting of high-intensity sweeteners, flavoring agents, natural extracts, acidulants, waxes, fillers, pigments and gloss agents (such as shellac).

The high-intensity sweetener contained in the gum base or the chewing gum composition may be one or more selected from the group consisting of aspartame, acesulfame potassium, sodium cyclamate, sodium saccharin, sucralose, a stevia sweetener (e.g., steviol glycoside, enzyme-treated stevia), dulc, thaumatin, tomatin, neotame, rebaudioside (such as rebaudioside A, rebaudioside D, and rebaudioside M), and monellin, but is not limited thereto.

The flavoring agent comprised in the gum base or chewing gum composition may be one or more selected from the group consisting of a single flavor compound and/or freeze-dried natural plant-derived components, for example essential oils and essences extracted and/or processed from plants. For example, the single perfume compound may include, but is not limited to, menthol, menthone, vanillin, ethyl vanillin, cinnamic acid, piperonal, d-borneol, maltol, ethylmaltol, Kamfer, methylanthranilate, cinnamic alcohol, methyl N-methylanthranilate, methyl-naphthylketone, limonene, linalool, and/or aryl isothiocyanate. In addition, the natural plant-derived component may include, but is not limited to, The natural plant-derived ingredients are coconut, coffee, chocolate, vanilla, grape, orange, lime, mint, licorice, caramel flavor, honey flavor, peanut, walnut, cashew, hazelnut, almond, pineapple, strawberry, raspberry, tropical fruit, cherry, Cinnamon, peppermint, wintergreen, spearmint, eucalyptus, and mint; fruit essences such as apple, pear, peach, strawberry, apricot, raspberry, cherry, pineapple and plum essences; and essential oils such as peppermint, spearmint, menthol, eucalyptus, clove oil, bay oil, anais, thyme, cedar leaf oil, nutmeg, and the aforementioned fruit oil.

As another example of the present invention, a method for producing a chewing gum composition containing sugar and allulose as saccharides is provided.

The descriptions relating to the chewing gum composition are equally applicable to the method of manufacturing chewing gum compositions.

The method may further comprise mixing sugar and allulose in a weight ratio of 99:1 to 1:99, or preferably 99:1 to 50:50. The sugar may be comprised between 50 and 90%, or preferably between 60 and 70% by weight based on 100% by weight of the total chewing gum composition, and allulose may be mixed so as to be 1 to 70%, or preferably 10 to 40% by weight, based on 100% by weight of the solid content of the composition.

The method may further comprise a step of adding an emulsifier, wherein the emulsifier may be mixed so as to include 0 to 3% by weight, or preferably from 0.1 to 1% by weight based on 100% by weight of the total solid content of chewing gum composition, and the emulsifier is an emulsifier having HLB value of 1 to 20, preferably 1 to 7, or more preferably 1 to 3.

In the preparation method of the present invention, when the allulose may be an allulose crystal, and may further comprise a cooling method, for example, cooling an allulose solution rapidly or slowly to induce a supersaturated state to produce a crystal. The cooling rate may be maintained, for example, 0.01 to 20° C./min. When preparing allulose crystals, it may be made with or without adding seeds, or it may include seeds to make crystals or to increase the crystal production rate/size.

The preparation method may further comprise a step of mixing one or more saccharides other than sugar and allulose, i.e., at least one selected from the group consisting of monosaccharides, disaccharides, sugar alcohols, dietary fibers and oligosaccharides.

The method may further comprise mixing at least one additive selected from the group consisting of gum bases, flavoring agents, acidulants, sweeteners, waxes, fillers, pigments, and gloss agents (such as shellac).

Another aspect of the present invention is to provide a method for increasing shelf stability and/or persistence of sweetness in a chewing gum composition by providing sugar, allulose and emulsifier.

The descriptions relating to the chewing gum composition are equally applicable to methods of increasing improved storage stability and/or moisture stability.

### Effect of Invention

The present invention relates to a chewing gum composition comprising sugar and allulose as saccharides, and an emulsifier having a low HLB value, where the composition has excellent sensory properties including very excellent sweet taste, a long persistence of sweet taste, and an excellent refreshing feeling, and has a good storage stability due to a low hygroscopicity.

### BRIEF DESCRIPTION OF DRAWINGS

FIG. 1 is a table showing the moisture absorption over time in the chewing gums of Examples 1 to 3 and Comparative Example 1 of the present invention.

### MODE FOR INVENTION

The present invention will be described in more detail by the following exemplary examples, but the protection scope of the present invention is not intended to be limited to the following examples.

Allulose Production

A high-purity allulose syrup containing 96% by weight of allulose was concentrated to a concentration of 81 Bx (%, w/w), and was slowly cooled from a temperature of 35° C. at which the supersaturation occurred to 10° C. to grow crystals. At this time, after the allulose seed crystals were added and slowly stirred at a temperature of 35° C. to produce a small amount of crystal nuclei, the temperature was decreased by 1° C. per hour to grow crystals, and in the crystal growth step, a step of increasing the temperature of the solution to 30-35° C. was performed, in order to re-dissolve the generated fine crystals during cooling. The crystallization was performed by repeating the crystal growth process and the microcrystalline dissolution process at least once or more. The prepared allulose crystals were recovered by removing the mother liquor by centrifugal dehydration and washing the crystals with cooling water, followed by drying. The yield of allulose crystallization was 61%.

The collected allulose crystals had an average particle size of 853.3 μm and an average short diameter of about 208.0 μm. In addition, as a result of DSC analysis (Diamond DSC, 30 to 250° C., 10° C./min elevated temperature, N2 gas purge), Tm (° C.) was found to be 125.8° C. and ΔH was 211.7 J/g. The XRD analysis results (D/MAX-2200 Ultrama/PC) of the allulose crystals are shown in Table 1 below.

TABLE 1

| Angle 2-Theta degree | Relative Intensity % |
|---|---|
| 15.35 | 100.0 |
| 18.83 | 4.4 |
| 25.17 | 1.8 |
| 30.95 | 11.7 |
| 47.15 | 2.8 |

### Examples 1-3. Chewing Gum Preparation

Chewing gum was prepared with the ingredients and compositions in Table 2 below, including xylitol, maltitol or sorbitol as sugar alcohols and the produced allulose. The emulsifier used was S370 with an HLB value of 3 and/or S770 with an HLB value of 7 (Mam Yung Commercial Co. ltd.). As a specific mixing step, the composition of the table below was placed and kneaded in a gum kneader and then mixed at a temperature of 40° C. to discharge when the network was completely formed in spread of the mixture. The gum composition was pressed into a mill to sit at 1.5 to 2 mm and cut.

TABLE 2

| | Exam- | Exam- | Exam- | Comparative |
|---|---|---|---|---|
| | ple 1 | ple 2 | ple 3 | Example 1 |
| Components | (wt %) | (wt %) | (wt %) | (wt %) |
| Allulose(Samyang Corp) | 10.24 | 10.24 | 10.24 | 10.24 |
| Xylitol (Samyang Corp) | 59.52 | 0 | 0 | 59.59 |
| Maltitol (Samyang Corp) | 0 | 59.18 | 0 | 0 |
| Sorbitol (Samyang Corp) | 0 | 0 | 59.52 | 0 |
| Sugar ester (S370) | 0.2 | 0.7 | 0.2 | 0 |
| Sugar ester (S770) | 0.02 | 0.02 | 0.02 | 0 |
| Sugar ester (S1670) | 0 | 0 | 0 | 0.2 |
| Maltitol syrup C | 3.29 | 3.27 | 3.29 | 3.26 |
| Gum base (Bolak Co. | 25.17 | 25.04 | 25.17 | 25.15 |
| Ltd) | | | | |
| L-menthol (Takasago | 0.1 | 0.1 | 0.1 | 0.1 |
| international Corp) | | | | |
| Citric acid (Samyang | 0.4 | 0.4 | 0.4 | 0.4 |
| Corp) | | | | |
| Sucralose (Samyang | 0.02 | 0.02 | 0.02 | 0.02 |
| Corp) | | | | |
| Acesulfame K | 0.04 | 0.04 | 0.04 | 0.04 |
| Flavor | 1 | 0.99 | 1 | 1 |
| Sum | 100 | 100 | 100 | 100 |

As a comparative example for Examples 1 to 6 above, a chewing gum was prepared in the same manner, but an emulsifier was prepared with the composition in Table 2 below including S1670 (Myamsian) having an HLB value of 16.

### Examples 4 to 6: Chewing Gum Preparation

The chewing gums containing allulose and sugar as saccharides in different ratios of amounts were prepared in the same manner as in the preparation methods of Examples 1 to 3 by using the compositions shown in Table 3 below. As a Comparative Example, a chewing gum was prepared with a composition containing sugar, starch syrup and glucose, but no allulose.

TABLE 3

| | Exam- | Exam- | Exam- | Comparative |
|---|---|---|---|---|
| | ple 4 | ple 5 | ple 6 | Example 2 |
| Components | (wt %) | (wt %) | (wt %) | (wt %) |
| Allulose(Samyang Corp) | 52.53 | 10 | 20 | 0 |
| Powdery sugar(Samyang | 0 | 42.53 | 32.53 | 52.55 |
| Corp) | | | | |
| Glucose(Samyang Corp) | 15.57 | 15.57 | 15.57 | 15.57 |
| Starch syrup(Samyang | 5.84 | 5.84 | 5.84 | 5.84 |
| Corp) | | | | |
| Sugar ester (HLB 7) | 0.02 | 0.02 | 0.02 | 0 |
| Gum base(Bolak Co. | 24.52 | 24.52 | 24.52 | 24.52 |
| Ltd) | | | | |
| L-menthol (Takasago | 0.1 | 0.1 | 0.1 | 0.1 |
| international Corp) | | | | |
| Citric acid(Samyang | 0.39 | 0.39 | 0.39 | 0.39 |
| Corp) | | | | |
| Sucralose (Samyang | 0.02 | 0.02 | 0.02 | 0.02 |
| Corp) | | | | |
| Acesulfame K (Samyang | 0.04 | 0.04 | 0.04 | 0.04 |
| Corp) | | | | |
| Flavor | 0.97 | 0.97 | 0.97 | 0.97 |
| Sum | 100 | 100 | 100 | 100 |

### Examples 7 to 9: Chewing Gum Preparation

According to the same production methods of Examples 1 to 3, the chewing gum was produced with the compositions shown in Table 4 below, containing allulose, sugar, glucose or starch syrup as saccharides, with varying the type and content of the emulsifier. The chewing gums were produced with no emulsifier (Comparative Example 3) or with containing only an emulsifier having an HLB value of 16 (Comparative Example 4).

TABLE 4

| | | | | Comparative | Comparative |
|---|---|---|---|---|---|
| | Example7 | Example8 | Example9 | Example3 | Example4 |
| Component | (wt %) | (wt %) | (wt %) | (wt %) | (wt %) |
| Allulose(Samyang Corp) | 20 | 20 | 20 | 20 | 20 |
| Powdery | 32.44 | 32.44 | 32.51 | 32.55 | 32.44 |
| sugar(Samyang Corp) | | | | | |
| Glucose(Samyang Corp) | 15.54 | 15.54 | 15.55 | 15.57 | 15.54 |
| Starch syrup(Samyang | 5.83 | 5.83 | 5.83 | 5.84 | 5.83 |
| Corp) | | | | | |
| Sugar ester (HLB 1) | — | 0.2 | 0.09 | — | — |
| Sugar ester (HLB 7) | 0.2 | — | — | — | — |
| Sugar ester (HLB 16) | — | — | — | — | 0.2 |
| Gum base (Bolak Co. | 24.47 | 24.47 | 24.5 | 24.52 | 24.47 |
| Ltd) (wt %) | | | | | |
| L-menthol (Takasago | 0.1 | 0.1 | 0.1 | 0.1 | 0.1 |
| international Corp) (wt %) | | | | | |
| Citric acid (Samyang | 0.39 | 0.39 | 0.39 | 0.39 | 0.39 |
| Corp) (wt %) | | | | | |
| Sucralose (Samyang | 0.02 | 0.02 | 0.02 | 0.02 | 0.02 |
| Corp) (wt %) | | | | | |
| Acesulfame K(wt %) | 0.04 | 0.04 | 0.04 | 0.04 | 0.04 |
| Flavor(wt %) | 0.97 | 0.97 | 0.97 | 0.97 | 0.97 |
| Sum(wt %) | 100 | 100 | 100 | 100 | 100 |

### Test Example 1. Moisture Absorption Evaluation

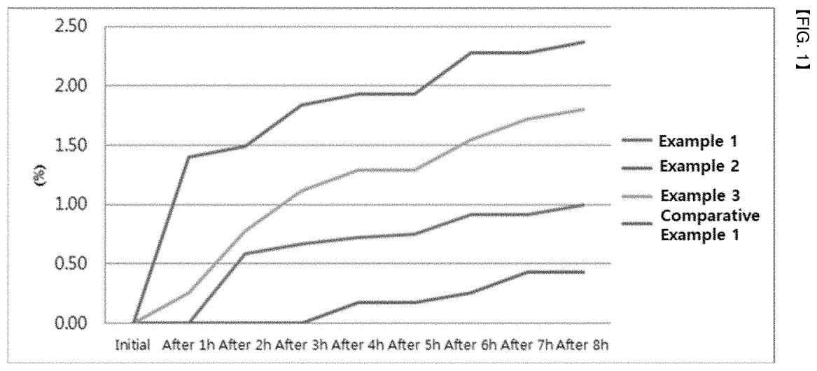

The chewing gums containing allulose of Examples 1 to 3, Examples 8 and 9 and Comparative Examples 1 to 4 were evaluated for moisture absorption over time. Specifically, the chewing gum prepared in the tray was weighed after 0, 2, 4, 6, or 8 hours under constant temperature (30° C.) and constant humidity (75% RH) conditions, and the increased weight calculated by the following formula (1) was calculated as the ratio over time, to show in Table 5, Table 6, and FIG. 1.

Hygroscopicity (%)={(weight of chewing gum at n hour)−(weight of chewing gum at 0 hour)}/(weight of chewing gum at n hour)×100% [Equation 1]

TABLE 5

| Storage | Exam- | Exam- | Exam- | Comparative |
|---|---|---|---|---|
| time | ple1(%) | ple2(%) | ple3(%) | Example1(%) |
| 0 h | 0.00 | 0.00 | 0.00 | 0.00 |
| 2 h | 0.58 | 0.00 | 0.77 | 1.49 |
| 4 h | 0.72 | 0.17 | 1.29 | 1.93 |
| 6 h | 0.92 | 0.26 | 1.55 | 2.28 |
| 8 h | 1.00 | 0.43 | 1.81 | 2.37 |

TABLE 6

| Storage | | | Comparative | Comparative | Comparative |
|---|---|---|---|---|---|
| time | Example8(%) | Example9(%) | Example2(%) | Example3(%) | Example4(%) |
| 0 h | 0 | 0 | 0 | 0 | 0 |
| 2 h | 0.36 | 0.48 | 0.42 | 0.55 | 0.65 |
| 4 h | 1.29 | 1.61 | 1.43 | 1.56 | 1.59 |
| 6 h | 1.77 | 1.87 | 1.98 | 2.07 | 2.12 |
| 8 h | 2.12 | 2.3 | 2.39 | 2.43 | 2.62 |

As could be shown from the above results, it was confirmed that the moisture absorptivity could be maintained to be lower as an emulsifier having a lower HLB value is used when the same saccharide was used, regardless of the type of sugar excluding allulose. In particular, in the case of Example 1 or 8 using an emulsifier having an HLB value of 1, the moisture absorption was significantly lower than that of the chewing gum of Comparative Examples 1 or 4 containing an emulsifier with an HLB of 16. It has been confirmed that even when the emulsifier was contained in a half amount (Example 9), it was possible to maintain low moisture absorption, compared to the use of an emulsifying agent having an HLB of 16.

### Test Example 2. Hardness Evaluation

The hardness of the chewing gums prepared in Examples 1 to 3 and Comparative Example 1 was measured by repeating the measurement five times at a speed of 1 mm/s using a probe having a diameter of 5 mm according to Punture Test (Measure Force in Compression) method.

The measurement results are shown in the following table. It was confirmed that the hardness of Examples 1 to 6 (HLB 1 or 7), in particular, Examples 3 to 6, using an emulsifier having a low HLB value was high.

TABLE 7

| | | | | Comparative |
|---|---|---|---|---|
| Item | Example1 | Example2 | Example3 | Example1 |
| Hardness(g) | 3.4 | 2.7 | 3.8 | 2.7 |

In the case of Comparative Example 1 containing xylitol as a sugar alcohol and an emulsifier having a high HLB value (HLB 16), the hardness was low and the physical properties were poor, so that chewing properties were expected to be poor. However, in Example 1 including an emulsifier having a low HLB value (HLB 3) had high hardness, showing that the hardness of a certain level or more could be imparted, even if sugar alcohol was included.

### Test Example 3. Sensory Evaluation

The sensory evaluation of the chewing gums of Examples 4 to 6 and Comparative Example 2 was carried out. While putting the sample in the mouth and chewing, the sweet taste intensity, sweet taste preference, hardness, and hardness preference were evaluated on a 5-point scale, and the preference was at the initial stage and three minutes after the sample was placed in a mouth. The results are shown in Table 8.

The evaluation criteria of the items are as follows, and the results are shown in the table below.

<Evaluation Criteria>

Sweetness: 5 points for high sweetness intensity and 1 point for low sweetness intensity.

Sweet taste preference: 5 points for excellent preference of sweetness quality and 1 point for low preference of sweetness quality

Hardness: 5 points for high hardness and 1 point for low hardness

Hardness preference: 5 points for excellent preference of hardness and 1 point for low preference of hardness.

TABLE 8

| | | | | Comparative |
|---|---|---|---|---|
| | Example4 | Example5 | Example6 | Example2 |
| Sweetness (initial) | 3.2 | 3.5 | 3.4 | 3.4 |
| Sweet taste preference | 3.0 | 3.7 | 3.6 | 3.8 |
| (initial) | | | | |
| Hardness (initial) | 3.1 | 3.2 | 3.2 | 3.1 |
| Hardness preference | 3.1 | 3.7 | 3.6 | 3.7 |
| (initial) | | | | |
| Sweetness | 2.1 | 3.1 | 3.2 | 2.5 |
| (after 3 minutes) | | | | |
| Sweet taste preference | 2.5 | 3.7 | 3.4 | 3.4 |
| (after 3 minutes) | | | | |
| Hardness | 3.8 | 2.8 | 2.8 | 3.2 |
| (after 3 minutes) | | | | |
| Hardness preference | 3.1 | 3.6 | 3.7 | 3.6 |
| (after 3 minutes) | | | | |
| refresh feeling | 3.4 | 3.3 | 3.2 | 3.2 |
| Overall preference | 2.5 | 3.5 | 3.4 | 3.5 |

As could be seen from the above results, it was confirmed that the chewing gum of Example 6, which was prepared with a composition containing about 53% by weight of allulose as a saccharide without including sugar commonly used in a conventional chewing gum composition, was not only low sweetness, but also increased hardness over time, as compared with the chewing gums of Comparative Example 2 containing no allulose.

In particular, in the case of Examples 5 and 6 prepared with the compositions containing sugar and allulose in a weight ratio of about 42:10 and 33:20 respectively, it was confirmed that the sweet taste was more highly felt as compared with Comparative Example 2 containing a large amount of sugar, and the sweet taste preference was high due to the refreshing feeling (cooling feeling). In addition, it was confirmed that Examples 5 and 6 had the effect of maintaining the sweet taste at a high level for a long time, as compared with that of Comparative Example containing only sugar or allulose.

1. A chewing gum composition comprising gum base, allulose and emulsifier, wherein the emulsifier has an HLB value of 1 to 8.

2. The chewing gum composition according to claim 1, wherein the moisture absorbed upon storage at a temperature of 30° C. and a relative humidity of 75% RH for 8 hours is 0.1 to 2.3% based on 100% by weight immediately after preparation.

3. The chewing gum composition according to claim 1, wherein the emulsifier is contained at 0.1% to 1% by weight based on 100% by weight of total solid content of chewing gum composition.

4. The chewing gum composition according to claim 1, wherein the emulsifier is at least one selected from the group consisting of monoglycerides and diglycerides (MD), sorbitan monostearate (SMS), sorbitan tristearate (STS), polyglycerol ester (PGE), lactic acid ester of monoglyceride and diglycerides (LMD), phosphoric acid ester of monoglyceride and diglycerides (PMD), monoglyceride diacetyl tartrate (DATEM), sugar ester and lecithin.

5. The chewing gum composition according to claim 1, wherein the allulose is contained at 10 to 40% by weight based on 100% by weight of total solid content of chewing gum composition.

6. The chewing gum composition according to claim 1, further comprising one or more additional saccharides selected from the group consisting of monosaccharides, disaccharides, sugar alcohols, dietary fibers, and oligosaccharides.

7. The chewing gum composition according to claim 6, wherein the sugar alcohols are one or more selected from the group consisting of xylitol, maltitol, erythritol, mannitol, lactitol, inositol and sorbitol.

8. The chewing gum composition of claim 6, wherein the additional saccharide is sugar, and wherein allulose and sugar are added such that the weight ratio of sugar and allulose is 1:99 to 99:1.

9. The chewing gum composition according to claim 1, wherein the gum base comprises 20 to 50% by weight based 100% by weight of total solid content of chewing gum composition.

10. The chewing gum composition according to claim 1, wherein the gum base are at least one selected from the group consisting of natural gums, polyvinyl acetates, polyisobutylenes, waxes, polybutenes, emulsifiers, fillers, and ester gums.

11. A sugar-free chewing gum composition comprising gum base, allulose, sugar alcohol and emulsifier, wherein the emulsifier has an HLB value of 1 to 8.

12. The chewing gum composition according to claim 1, wherein the allulose is an allulose crystal having an X-ray spectrum which has a peak at angles of diffraction (2θ)±0.2° of (a) 15.35, 30.95, 18.83, and 47.15; or (b) 15.35, 30.95, 18.83, 47.15, and 25.17.

13. A method of preparing a chewing gum composition comprising a step of mixing allulose, emulsifier and gum base, wherein the emulsifier has an HLB value of from 1 to 8.

14. The chewing gum composition of claim 1, wherein the emulsifier has an HLB value of 1 to 3.

15. The sugar-free chewing gum composition according to claim 11, wherein the allulose is an allulose crystal having a peak on a powder X-ray spectral spectrum at 2θ±0.2° of (a) 15.35, 30.95, 18.83, and 47.15; or (b) 15.35, 30.95, 18.83, 47.15, and 25.17.
